(19) United States
(12) Patent Application Publication
(10) Pub. No.: US 2023/0019774 A1
(43) Pub. Date: Jan. 19, 2023

(54) Oscillating Fishing Lure

(71) Applicant: FIDDLER DESIGN, INC., Mundelein, IL (US)

(72) Inventors: Sean Paul Ostruszka, Mundelein, IL (US); John Vincent Zambrzycki, Orland Park, IL (US)

(21) Appl. No.: 17/950,466

(22) Filed: Sep. 22, 2022

Related U.S. Application Data
(63) Continuation-in-part of application No. 16/524,005, filed on Jul. 26, 2019.

(51) Int. Cl. A01K 85/00

(52) U.S. Cl. CPC A01K 85/1807; A01K 85/1803; A01K 85/1867

(57) ABSTRACT

The oscillating fishing lure is a fishing lure comprising: a body with a longitudinal axis, an uppermost surface, at least one hook, said first hook including a shank and a hook end, said shank being coupled to said body; a blade having an edge proximal to said body, wherein, during retrieval, a majority of said blade is oriented below said uppermost surface of said body; a joining mechanism whereby said blade is moveably coupled to said body, wherein said blade has freedom to move with respect to the roll, pitch and yaw axis only within strict mathematical limits; a line attachment mechanism, through which a fishing line is attached to the lure; and whereby retrieval of the lure causes the blade to oscillate in at least one dimension, and thereby causing the lure to erratically hunt. The oscillating-blade action imparts a natural swimming motion to the lure, emulating prey-species movements.

### CROSS-REFERENCE TO RELATED APPLICATIONS

This application comprises a continuation-in part of application of U.S. application Ser. No. 16/524,005 filed Jul. 26, 2019, which is hereby incorporated by reference.

### TECHNICAL FIELD

The present invention relates to fishing lures; in particular, lures that incorporate an oscillating motion. Specifically, the invention is a fishing lure having a blade member uniquely attached to a weighted body to provide an intense vibrating action as movement through water controllably displaces the blade in three dimensions.

### BACKGROUND OF THE INVENTION

It is desirable for a fishing lure to include a blade or other feature to create motion, reflect light and give the lure a simulated natural swimming motion resembling a minnow or other food source for the sport fish being sought. While many lures are designed to attract fish in novel ways, none achieve a controlled or controllable oscillating action that is also erratic and can be altered by the user to change the motion of the lure. Thus, there is a need for a lure which produces an underwater movement that is attractive to fish.

U.S. Pat. No. 10,085,432 issued Oct. 2, 2018, and U.S. Pat. No. 9,572,331 issued Feb. 21, 2017, both to A. Reyment describe a variable-depth fishing lure that wherein the depth is controlled by a spring-loaded indexing mechanism which alters the angle of the blade with respect to the body in fixed, locked increments.

U.S. Pat. No. 9,265,239 issued Feb. 23, 2016, and U.S. Pat. No. 8,429,847, issued Apr. 30, 2013, both to R. Ford describes a fishing lure with a lure-positioning arm attached to the forward-protruding blade. The lure-positioning arm's position controls the ability of the lure to dive.

U.S. Pat. No. 9,253,967, issued Feb. 9, 2016, U.S. Pat. No. 7,726,062, issued Jun. 1, 2010, and U.S. Pat. No. 7,627,978, issued Dec. 8, 2009, all to J. R. Davis describe a fish lure having a jig and a blade attached in a configuration which limits the side-to-side movement of the blade. The blade is limited in its side-to-side motion by contact between the blade edge and either the jig body or the eyelet, of which the blade must pass through via a hole in the blade. The uncontrolled but limited side-to-side movement of the blade creates a quick, oscillating blade action that imparts a natural swimming motion to the lure, emulating prey species movements.

U.S. Pat. No. 8,146,288 issued Apr. 3, 2012 to J. Barczak, et al., describes a fishing lure with a fixed but rotatable head member, wherein the orientation of the head (and its attached blade) along the center line causes the lure to move in a particular direction when retrieved.

U.S. Pat. No. 7,621,068 issued Nov. 24, 2009 to J. Renosky describes a fishing lure with a blade coupled to the nose of the lure, wherein the blade is uncontrollably free to move in three dimensions save for contact with the body, or limitations imposed by the fit of the blade hole and eyelet.

U.S. Pat. No. 7,107,720 issued Sep. 19, 2006, to R. Burggrabe, et al., describes a fishing lure with a shaped blade protruding from the forward edge of the body wherein the fishing line is attached near the middle of the blade. The shape of the blade and the location of the line attachment mechanism control the depth the lure will run.

U.S. Pat. No. 5,351,433 issued Oct. 4, 1994 to J. Ellis describes a fishing lure with a replaceable bib (front blade). The blades may have different shapes/sizes such that changing out the blade will allow the user to alter the depth the lure will run.

U.S. Pat. No. 5,337,508 issued Aug. 16, 1994 to C. Pfeiffer describes a fishing lure with a moveable front blade. Although the blade can move laterally, this lateral motion is uncontrolled and limited solely by the blade impinging upon the body or via contact with internal members, which also serve to affix the blade to the body. Although there are mechanisms expressed to limit the lateral (yaw) motion of the blade, there are no mechanisms expressed to limited the roll or pitch motion of the blade, nor to suggest that the blade has any ability to move in those other directions.

U.S. Pat. No. 4,777,761 issued Oct. 18, 1988 to R. Renaud describes a fishing lure having a moveable front blade. As in the '508 patent to Pfeiffer, the blade is allowed to move laterally until it impinges on the body or upon a spring stop located within the “mouth” of the body. As in the Pfeiffer patent, although there are mechanisms expressed to limit the lateral (yaw) motion of the blade, there are no mechanisms expressed to limited the roll or pitch motion of the blade, nor to suggest that the blade has any ability to move in those other directions.

None of the above inventions and patents, taken either singly or in combination, is seen to describe the instant invention as claimed.

### SUMMARY OF THE INVENTION

The invention comprises several general aspects. Each of those can, if desired, be combined with additional features, including features disclosed and/or not disclosed herein, the resultant combinations representing more detailed optional embodiments of these aspects.

The following discussion of advantages is not intended to limit the scope of the invention, nor to suggest that every form of the invention will have all of the following advantages. As will be seen from the remainder of this disclosure, the present invention provides a variety of features. These can be used in different combinations. The different combinations are referred to as embodiments. Most embodiments will not include all of the disclosed features. Some simple embodiments can include a very limited selection of these features. Those embodiments may have only one or a few of the advantages described below. Other preferred embodiments will combine more of these features and will reflect more of the following advantages. Particularly preferred embodiments, which incorporate many of these features, will have most if not all of these advantages. Moreover, additional advantages, not disclosed herein, that are inherent in certain embodiments of the invention will become apparent to those who practice or carefully consider the invention.

This invention overcomes problems inherent in fishing lures, in particular, in fishing lures that oscillate in an attempt to mimic the natural swimming motion of prey fish.

Previous attempts have significant limitations in motions and deficiencies in both manufacturability and operation, which the present invention overcomes.

In a first aspect, the invention comprises a fishing lure comprising:

a body with a longitudinal axis, an uppermost surface, at least one hook, said first hook including a shank and a hook end, said shank being coupled to said body; a blade having an edge proximal to said body, wherein, during retrieval, a majority of said blade is oriented below said uppermost surface of said body; a joining mechanism whereby said blade is moveably coupled to said body, wherein said blade has freedom to move with respect to the roll, pitch and yaw axes within strict limits; a line attachment mechanism, through which a fishing line is attached to the lure; and whereby retrieval of the lure causes the blade to randomly oscillate in at least one dimension, and thereby causing the lure to erratically hunt. The oscillating-blade action imparts a natural swimming motion to the lure, emulating prey species movements.

The blade can be configured to allow multiple degrees of freedom of motion, depending on the style and/or form the joining mechanism takes. In general, all forms and styles should allow the blade limited and controlled freedom of motion about one or more of the roll, pitch and yaw axes.

The body may take various sizes, shapes and geometries, depending on the type of baitfish being emulated. The body may be short and fat, long and fat, long and thin, or short and thin.

The blade may be coupled to the body in various locations, have various orientations, and have various sizes, lengths and geometries and/or features. The blade may be shallow- or deep-set within the body, may be mounted nearly parallel to the longitudinal line of the body or may be at a depressed angle relative to that line, and may be mounted at the nose/mouth of the body, or in back and/or below the nose/mouth.

In certain embodiments of the foregoing general aspect, the blade may have length and width relative to the lure body. The blade width at its widest may be 25%, 100% or 200% the width of the body at its widest; the blade length, measured as the amount of blade protruding past the forward-most point of the body, may be 10%, 50%, or 200% the length of the body. The geometry of the blade, irrespective of its relative length or width, may comprise sides and/or leading edges that may be convex, concave or straight, or some combination of convex, concave and straight. The blade structure may be straight (planar), comprise a curve in one or more dimensions, be bent/angled, or have a stepped structure. Additionally, the blade may incorporate various features, such as raised edges, which may be continuous or interrupted, and wherein these features may be symmetrical or non-symmetrical, and/or identical or non-identical.

In one embodiment of the foregoing general aspect, the strict limits of motion along the roll axis may be 0 degrees, less than 5 degrees, or less than 12 degrees.

In another embodiment of the foregoing general aspect, the strict limits of motion along the pitch axis may be 0 degrees or less than 10 degrees.

In still another embodiment of the foregoing general aspect, the strict limits of motion along the yaw axis may be 0 degrees or less than 45 degrees.

In yet another embodiment of the foregoing general aspect, the total angular displacement of the blade in the combined values of roll, pitch and yaw may be less than 60 degrees.

In various embodiments of the first mentioned general aspect, the hunting action of the lure may be erratic and/or may be off bore. Additionally, the erratic and/or off-bore hunting action may be achievable while the lure is retrieved at low speed, high speed, or any combination of low and high speeds, and is in fact independent of the retrieval speed of the lure.

In still other embodiments of the foregoing general aspect, the line attachment mechanism may comprise an eyelet attached to the lure body or the lip, a through hole, within the lure body or the lip, or may comprise a clip, said clip being coupled to the lure body or the lip.

### BRIEF DESCRIPTION OF THE DRAWINGS

The invention will be described in detail with reference to the accompanying drawings. Each of the figures is a schematic diagram more fully described below.

FIG. 1 is a perspective view of the fishing lure, including at least one hook and a blade.

FIG. 2 is a perspective of the fishing lure, detailing the roll, pitch and yaw axes with respect to the blade and the body; the roll axis being more or less defined by the major axis running through the longitudinal axis of the body of the lure.

FIG. 3 is a side view of the lure, showing some of the body shapes/sizes available in this invention, to wit: a short, squat body; a long, squat body; a short, thin body; and a long, thin body. Additionally, these figures show the blade may be shallow- or deep-set within the body, may be mounted nearly parallel to the longitudinal line of the body or may be at a depressed angle relative to that line, and may be mounted at the nose/mouth of the body, or in back and/or below the nose/mouth.

FIG. 4 is a top-down view of lure, detailing the variations in ratios of the length of the extension of the blade beyond the body to the overall body length available with this invention, to wit: ratios of 200%, 50% and 10%.

FIG. 5 is a top-down view of the front portion of the lure, detailing the variations in blade width to body width ratio available with this invention (both measured at their widest points), to wit: a blade that is at least 25%, 100% and 200% the width of the body.

FIG. 6 is a top-down view of the front portion of the lure, showing some of the variations in geometry of the blade available within this invention. As can be seen, the sides and front edge of the blade can have different geometries, and can be various combinations of concave, convex, or straight.

FIG. 7 is a perspective view of the front portion of the lure, detailing some of the variations in blade structure available within this invention. As shown, the blade may be straight (planar), may comprise a curve in one or more dimensions, may be spoon shaped, may be bent/angled, or may have a stepped structure.

FIG. 8 shows additional features that may be present on the blade. The blade may incorporate raised edges on its upper and/or lower surfaces. The raised edges may be continuous or discontinuous. When discontinuous, the discontinuous segments may be symmetrical or non-symmetrical, and/or identical or non-identical.

FIG. 9 details the various locations and mechanisms through which a line may be attached to this lure. The line may be attached via an eyelet, a through hole, or a clip, and said eyelet, through hole or clip may be located at the nose or top of the head of the lure, or located in the blade.

FIG. 10 is a front-facing perspective of lure of FIG. 1, wherein the roll axis and the limitation on the blade's freedom of motion in the roll axis are documented.

FIG. 11 is a side-facing perspective of lure of FIG. 1, wherein the pitch axis and the limitation on the blade's freedom of motion in the pitch axis are documented.

FIG. 12 is a front-facing perspective of lure of FIG. 1, wherein the yaw axis and the limitation on the blade's freedom of motion in the yaw axis are documented.

FIG. 13 shows the erratic hunting path of the lure at both a low-speed retrieval and a high-speed retrieval. The high-speed retrieval results in a more pronounced off-bore travel, but in both cases the lure always returns to bore.

### DETAILED DESCRIPTION OF THE DRAWINGS

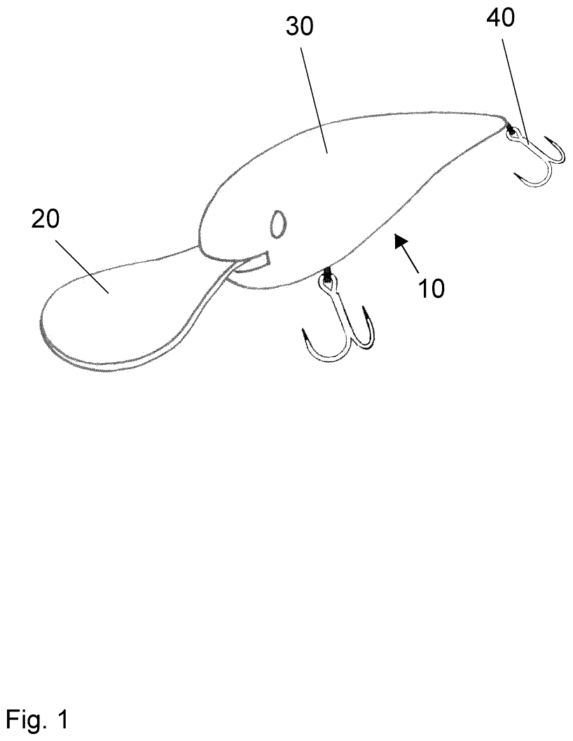

The present invention is a fishing lure with an oscillating blade, designated generally as 10 in the drawings. Referring to FIG. 1, fishing lure 10 comprises a blade 20, a body 30, and a hook 40. As the lure is pulled through the water, the water rushing past the blade causes the blade to oscillate relative to the movement of the lure.

In FIG. 1, blade 20 is attached to body 30 at the mouth 50 of the body, slightly below the middle, and at a slightly depressed angle relative to the body's longitudinal axis. One hook 40 is located at the extreme trailing edge of the body, with a second hook located under the body slightly forward of the mid-section.

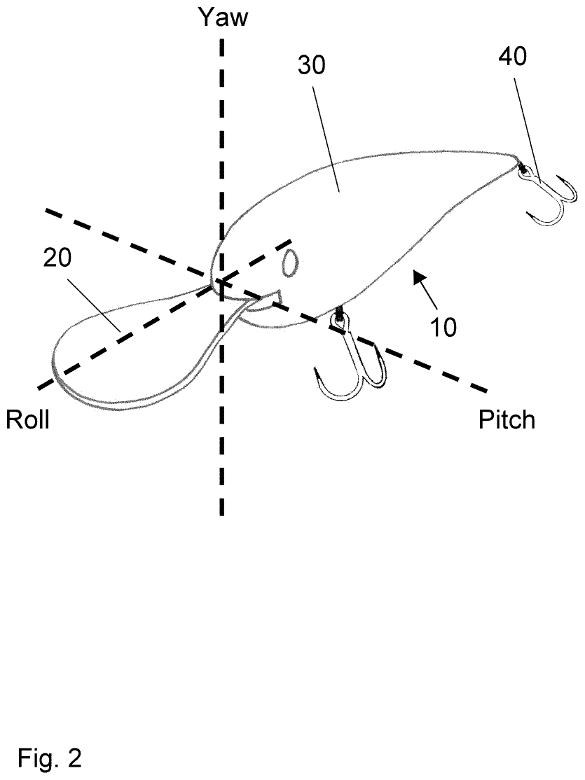

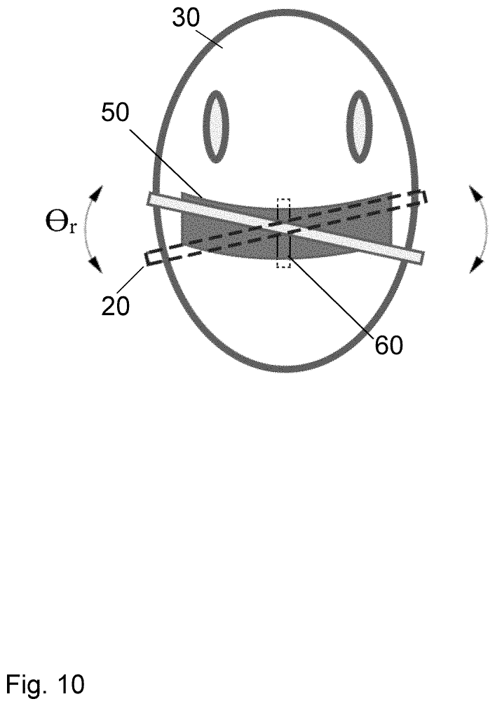

FIG. 2 details the roll, pitch and yaw axis relative to the body. In the instant drawing, the blade is free to oscillate in a strictly controlled fashion about roll, pitch and yaw axes as described in reference to FIGS. 10-12 below. As the lure is pulled through the water, the flow over the blade creates various regions of lift and drag, causing the blade and the blade-body combination to move in random, unpredictable patterns.

If the blade was fixed, as in most prior inventions and nearly all currently available devices, and the lure was retrieved slowly, a steady laminar flow regime develops over the blade, allowing these past lures to move in a linear fashion with little if any hunting action. However, as the retrieval speed is increased, the fixed blade-body combination would eventually face uneven forces typically causing the lure to rotate about its longitudinal axis until it was belly up.

Attempts to stop this from happening and create a more natural hunting motion were proposed by Pfeiffer (U.S. Pat. No. 5,337,508) and Renaud (U.S. Pat. No. 4,777,761). Their proposed solutions comprised a blade that was allowed to swivel laterally. However, both of these solutions fail because they failed to appreciate the hydrodynamic forces impacting the blade (and blade-body combination) upon retrieval. While the swiveling blade does create some limited hunting action, because the lateral motion is uncontrolled, the designs have inherent hydrodynamic instability—the blade gets locked into it farthest left or right position, causing lift on only one side of the lure, which causes the lure to rotate over its longitudinal axis, and the lure goes belly up.

In order to stop their inherent hydrodynamic instability, both attempted to limit the lateral range of motion of their blades by physical contact with the lure body, or with internal structures in the mouth of the lure. The greater the reduction in yaw allowed, the lower the chance of dynamic instability. However, the greater the reduction in yaw allowed, the lower the chance of achieving actual hunting action. Thus, regardless of their efforts to randomly physically limit yaw, any increase in speed above bare minimum headway speed would result in dynamic instability, the blade would lock into its farthest left or right position, the lure would rotate, and eventually, the lure would be belly up. As such, the designs expressed in their patents, attempting to blindly limit yaw without understanding the hydrodynamic forces at play, fail to operate with the hunting motion they describe, and more often than not, result in their lures rotating belly up and failing to hunt at all.

The present invention overcomes these deficiencies by strictly limiting the motion of the blade with respect to roll, pitch and yaw within prescribed boundaries. While the prior art discusses somewhat random (i.e., uncontrolled) limitations solely with respect to yaw based on physical interference with the blade, the present invention controls the freedom of motion of the blade within strict 3-dimensional boundaries. Although various mechanisms for achieving this control are well known, the need for strictly limiting the 3-dimensional freedom of motion of the blade within prescribed boundaries, and the boundaries themselves, were not known prior to the present invention.

While the general boundary limits are expressed within the present invention, they can be tailored depending on various physical features of the body and blade. Doing so allows the lure of the present invention to mimic not only the size and shape of various baitfish, but the motions typically expressed.

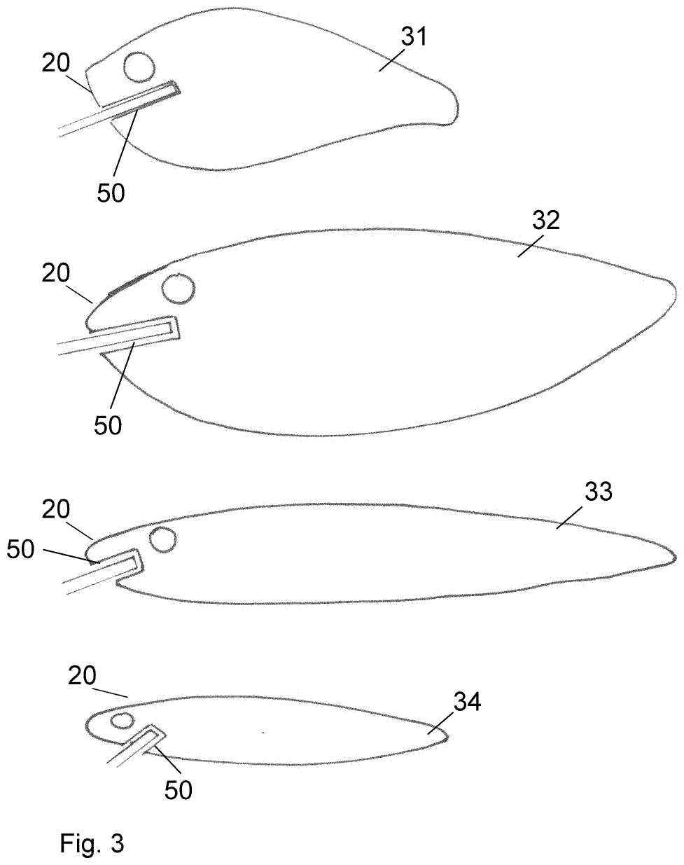

Examples of some of the sizes and shapes of bodies 30 are shown in FIGS. 3 (31, 32, 33, and 34). As detailed, the body can be short and squat 31, long and squat 32, long and thin 33, or short and thin 34. FIG. 3 also details how the blade 20 can be set at various depths within the body, at various locations within the body, and at various angles relative to the body's longitudinal axis. In nearly all instances of the present invention, the blade has at least a shallow angle of depression, although this can vary based on the blade geometry and features.

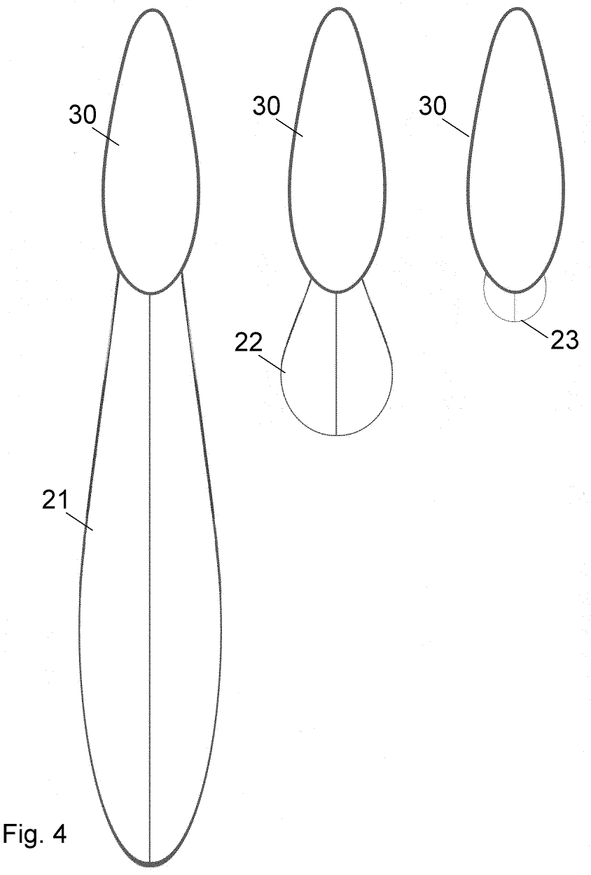

Different blades with different geometries and features can be used with a particular body style, giving the lure a different hunting action. The differences in the size, length, width, and geometries of the blade can be more readily observed in FIGS. 4-8.

FIG. 4 details variations in the ratio between body length and exposed blade length. By way of explanation, the exposed blade length is calculated independent of the attachment point or location, and only measures the observed length of the blade forward of the nose of the body when viewed from overhead. As shown, body 30 has a constant length, while blades 21, 22 and 23 are, respectively, 200%, 50%, and 10% the length of body 30.

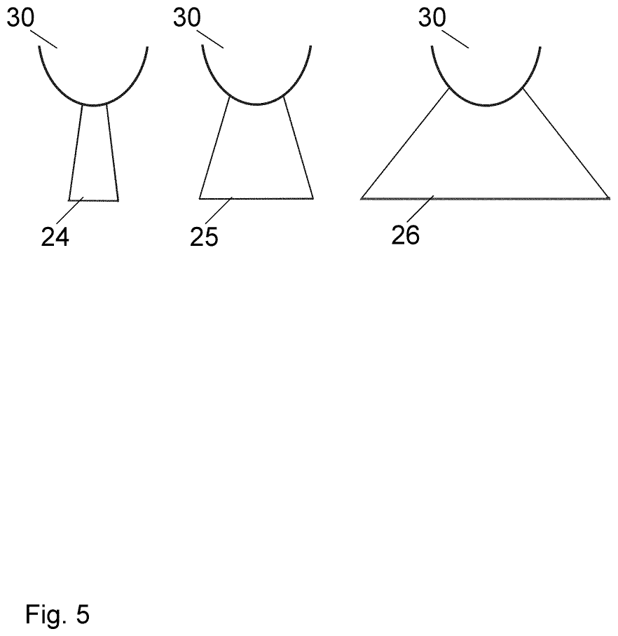

FIG. 5 details variations in the ratio between body width and blade width (both measured at their widest points). While body 30 has a constant width in all three examples, blade 20 can vary from thin to wide, or as shown in this example, from 25% (24), 100% (25), and 200% (26) the relative width of the body.

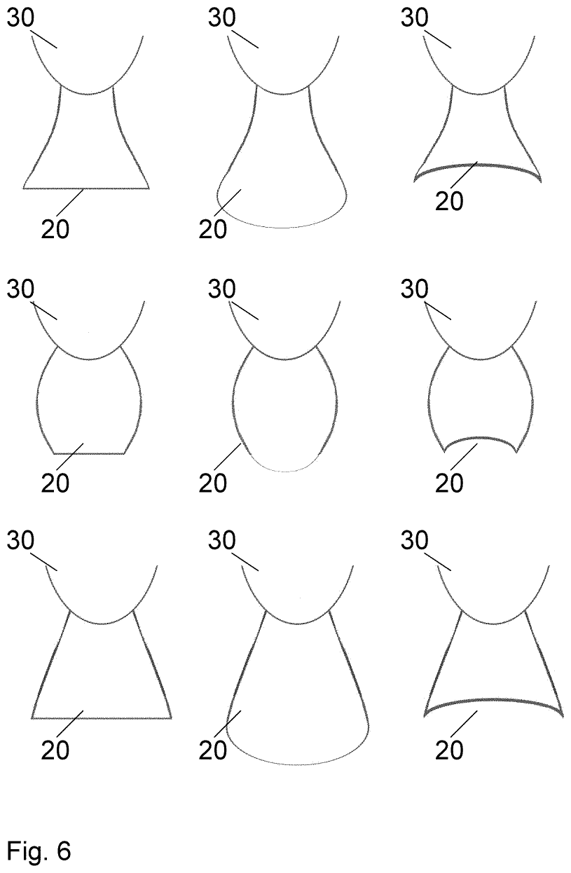

As has been seen, the length and width of blade 20 can be changed in order to accommodate different hunting actions. Likewise, as in FIG. 6, blade 20 can have different geometries. As viewed from top-down, showing only the nose of body 30, the sides and front edge of blade 20 can be variously concave, convex, straight, or combinations of concave, convex, and straight. The different geometries generate different flow regimes, which, in combination with variations in blade length and width, generate different hunting actions and paths.

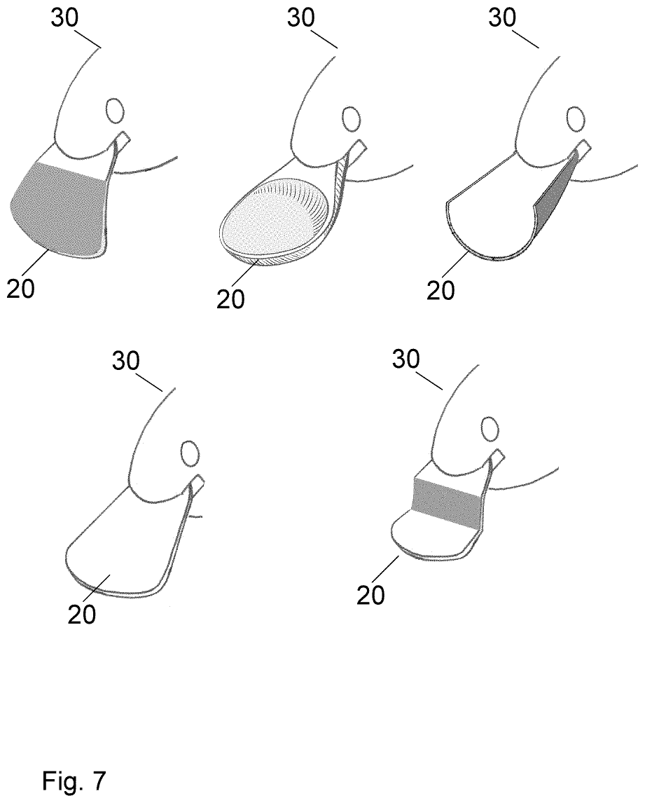

FIG. 7 details some of the different 3-dimensional shapes blade 20 may have in conjunction with variations in blade geometry expressed in FIG. 6. Blade 20 may be planar, may bend in one or more dimensions, may comprise a curve, may be spoon shaped, or may comprise multiple segments with different angles or curves. As stated earlier, each of these different 3-dimensional shapes creates different flow regimes, and thus, different hunting actions and paths.

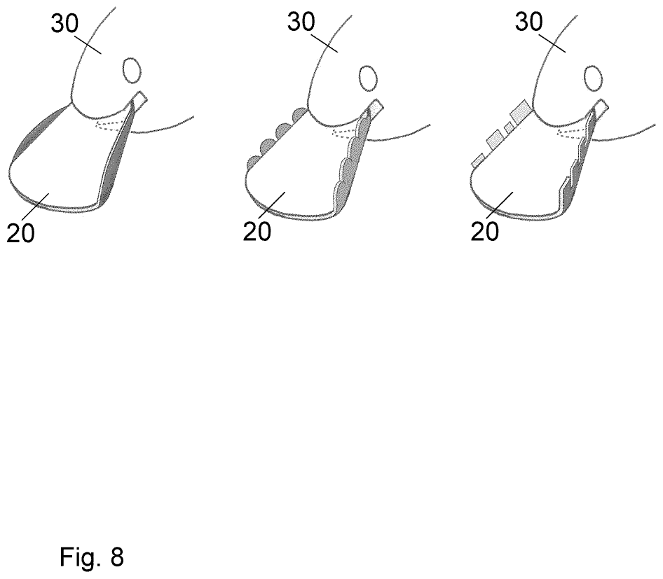

Aside from the various 3-dimensional shapes and edge geometries already expressed, blade 20 can incorporate various surface features, which can change the flow regime over the blade, and thus alter the hunting path and action of the lure. FIG. 8's three examples show a perspective view of the head of body 30 and a blade 20. In these examples, blade 20 comprises either continuous or discontinuous raised edges on the upper surface. For the discontinuous edges, the discontinuities may be symmetrical or non-symmetrical, and/or identical or non-identical. Although not shown, these surface features can be on either the upper or lower surface, or on both, and may exist as shown on the edges, or at locations other than the edges.

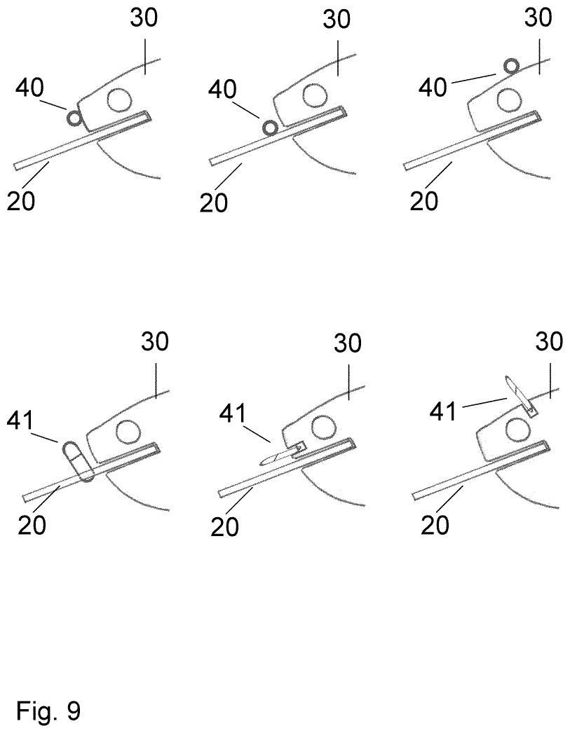

The lure must be pulled by a line to be retrieved. The location of the attachment of the line can alter the flow regime over the blade due to the angle of the force imparted from the line during retrieval. As shown in FIG. 9, the present invention may have various different locations, and connection mechanisms, for attaching a line to the lure. As detailed in the drawings, the line can be attached via an eyelet 40 (or a through hole in the body, which would serve the same purpose), or via a clip 41. Based on the size of the body, the size of the blade, or the attachment location and angle of the blade, the attachment location can be on the nose of the body, the head of the body, or on the blade.

FIGS. 10, 11, and 12 detail, respectively, the roll angle Θᵣ, the pitch angle Θₚ and the yaw angle Θ_{y} of the blade relative to the body. FIG. 10 is a front view of the lure, showing the limitations in roll angle Θᵣ, in this instance, based on the size of the body opening or mouth 50 for blade 20 relative to the blade thickness. While the present example shows a fixed mouth 50 for receiving the blade, one or more inserts can be place into the mouth (or onto the blade) to reduce the ratio of mouth height to blade thickness, to further limit roll angle. In some embodiments, the roll angle Θᵣ is limited to 12 degrees. In another embodiment, the roll angle Θᵣ is limited to 5 degrees. In a still further embodiment, the roll angle Θᵣ is limited to 0 degrees.

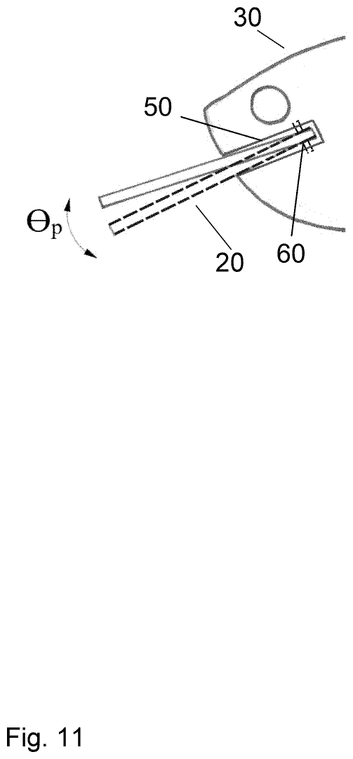

FIG. 11 shows pitch angle Θₚ by way of a side view of the front portion of body 30. Pitch angle Θₚ is governed by the depth of blade 20 into body 30, the location and type of the attachment mechanism within the mouth 50, and ratio of mouth height to blade thickness. Controlling for these three factors yields precise control of the available pitch blade 20 is allowed to experience. In one embodiment, the pitch angle Θₚ is limited to 10 degrees. In another embodiment, the pitch angle Θₚ is limited to 0 degrees.

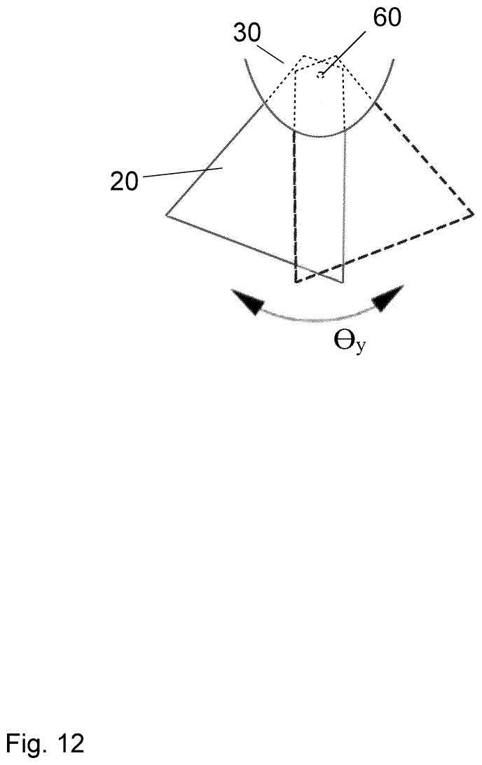

FIG. 12 is a top-down view of the nose of body 30 showing the yaw angle Θ_{y} available to blade 20. As the prior art has readily detailed, yaw angle Θ_{y} can be readily controlled by limiting the width of the mouth 50 (which receives the blade), or through various inserts or other structures to limit the lateral range of motion. In one embodiment, the yaw angle Θ_{y} is limited to 45 degrees. In another embodiment, the yaw angle Θ_{y} is limited to 0 degrees.

Although these control mechanisms are well known in the art, the precise limits expressed within this invention are the key to overcoming the failures of previous designs, and creating a lure which can actually hunt in a random, erratic off-bore fashion, regardless of retrieval speed.

As noted above, each of the roll angle Θᵣ, the pitch angle Θₚ, and the yaw angle Θ_{y} is governed in part by the attachment mechanism within the mouth 50 of the body 30. The blade 20 may be connected to the body 30 through any conventional means, such as use of a pin 60 as illustrated. For example, the blade 20 includes a bore through which the pin 60 extends. Openings within the mouth 50 of the body 30 are sized and positioned to receive opposing ends of the pin 60 in order to retain the blade 20 in position relative to the body 30.

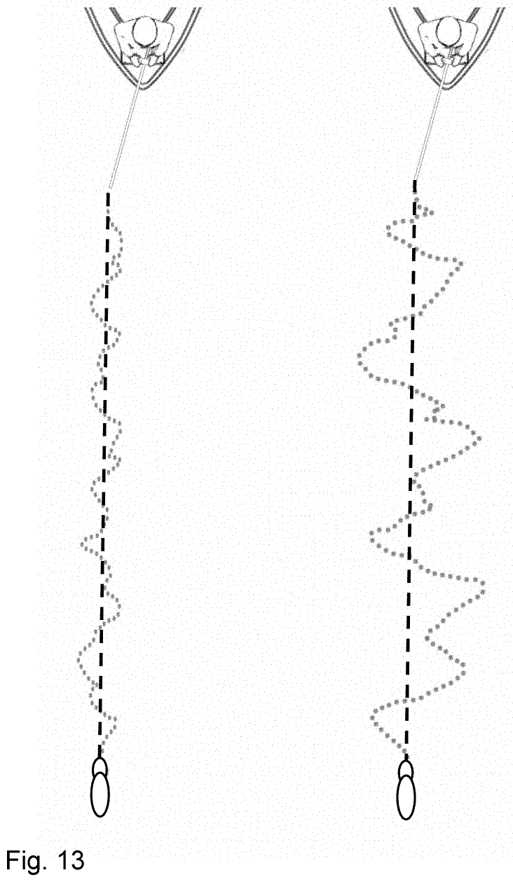

FIG. 13 details two examples of the off-bore, erratic hunting path achievable by the present invention. As expressed elsewhere, the geometry and shape of blade 20, its size relative to body 30, and the retrieval speed can alter the hunting behavior, introducing erratic, random path generation as the lure is retrieved.

Lastly, it is to be understood that the present invention is not limited to the embodiments described above, but encompasses any and all embodiments within the scope of the following claims, individually, or in variations combinations.

1. A fishing lure comprising:
a body with an uppermost surface and a rearward surface, wherein the body defines roll, pitch, and yaw axes,
a hook including a shank and a hook end, the shank being coupled to the body;
a blade having an edge received within the body, wherein, during retrieval, a majority of the blade is oriented below the uppermost surface of the body;
wherein the blade is moveably coupled to the body such that the blade has freedom to move about the roll, pitch, and yaw axes, wherein movement of the blade along the roll axis is less than 12 degrees, movement of the blade along the pitch axis is less than 10 degrees, and movement of the blade along the yaw axis is less than 45 degrees; and
a line attachment mechanism configured for attaching a fishing line to the lure;
whereby retrieval of the lure causes the blade to oscillate relative to the body along at least two of the roll, pitch, and yaw axes.

2. The fishing lure as in claim 1 wherein the blade is configured to oscillate along the roll axis up to 0 degrees.

3. The fishing lure as in claim 1 wherein the blade is configured to oscillate along the roll axis to less than 5 degrees.

4. The fishing lure as in claim 1 wherein the blade is configured to oscillate along the roll axis to less than 12 degrees.

5. The fishing lure as in claim 1 wherein the blade is configured to oscillate along the pitch axis to less than 10 degrees.

6. The fishing lure as in claim 1 wherein the blade is configured to oscillate along the yaw axis to less than 45 degrees.

7. The fishing lure as in claim 1 wherein the blade is configured to oscillate along the roll, pitch, and yaw axes having a total angular motion of less than 60 degrees.

8. The fishing lure as in claim 1 wherein the blade has a width that is at least 25% of a maximum width of the body.

9. The fishing lure as in claim 1 wherein the blade has a width that is at less than 200% of a maximum width of the body.

10. The fishing lure as in claim 1 wherein a length of an extension of the blade beyond a front edge of the body is less than 10% of a length of the body.

11. The fishing lure as in claim 1 wherein a length of an extension of the blade beyond a front edge of the body is less than 50% of a length of the body.

12. The fishing lure as in claim 1 wherein a length of an extension of the blade beyond a front edge of the body is less than 100% of a length of the body.

13. The fishing lure as in claim 1 wherein the line attachment mechanism comprises at least one through hole located in the body.

14. The fishing lure as in claim 1 wherein the line attachment mechanism comprises an eyelet affixed to the body.

15. The fishing lure as in claim 1 wherein the line attachment mechanism comprises at least one through hole located in the blade.

16. The fishing lure as in claim 1 wherein the line attachment mechanism comprises at least one eyelet located affixed to the blade.

17. A method of fishing in a body of water, the method comprising:
providing a fishing lure including:
a body with an uppermost surface and a rearward surface, wherein the body defines roll, pitch, and yaw axes,
a hook including a shank and a hook end, the shank being coupled to the body;
a blade having an edge received within the body, wherein, during retrieval, a majority of the blade is oriented below the uppermost surface of the body;
wherein the blade is moveably coupled to the body such that the blade has freedom to move about at least one of the roll, pitch, and yaw axes, wherein movement of the blade along the roll axis is less than 12 degrees, movement of the blade along the pitch axis is less than 10 degrees, and movement of the blade along the yaw axis is less than 45 degrees; and
a line attachment mechanism configured for attaching a fishing line to the lure;
casting the fishing lure in the body of water;
retrieving the fishing lure from the body of water along a bore path, wherein retrieval of the fishing lure causes the blade to oscillate relative to the body along the at least one of the roll, pitch, and yaw axes such that the fishing lure travels along an erratic hunting path.

18. The method of claim 17, wherein the fishing lure travels along the erratic hunting path when the fishing lure is retrieved at a high speed.

19. The method of claim 17, wherein the fishing lure travels along the erratic hunting path when the fishing lure is retrieved at a low speed.

20. The method of claim 17, wherein the fishing lure travels along the erratic hunting path independent of a speed at which the fishing lure is retrieved.
